(19) United States
(12) Patent Application Publication
(10) Pub. No.: US 2024/0070750 A1
(43) Pub. Date: Feb. 29, 2024

(54) SYSTEM, APPARATUS AND METHOD FOR PREDICTIVE BUNDLING OF INDUSTRIAL ITEMS

(71) Applicant: Berry Global, Inc., Evansville, IN (US)

(72) Inventors: Bobby Dean Smith, JR., Sand Springs, OK (US); William Oncay, Evansville, IN (US); Owen Richardson, Evansville, IN (US); Jeff Bercume, Evansville, IN (US); John Piette, Evansville, IN (US)

(21) Appl. No.: 18/238,222

(22) Filed: Aug. 25, 2023

Related U.S. Application Data
(60) Provisional application No. 63/401,221, filed on Aug. 26, 2022.

(51) Int. Cl. G06Q 30/0601

(52) U.S. Cl. CPC G06Q 30/0631

(57) ABSTRACT

Communications server system, method, and apparatus for managing complex orders of industrial supplies, comprising a processor and a memory, the communications server apparatus being configured, under control of the processor, to execute instructions in the memory to generate, for a plurality of orders of respective different order quantities associated with an order entity, each of the plurality of orders associated with a unique order rule set, determine, for each unique order, a first order element of a first order category, a value of a first attribute parameter indicative of a first order rule requirement determine, for each unique order for a second order element of a second order category, a value of a second attribute parameter indicative of a second order rule requirement compare the values for the first and second order attribute parameters with a minimum order rules set associated with the order entity, use a comparison result to recommend an order change to at least one of the first or second order elements to the order entity

### CROSS-REFERENCE TO RELATED APPLICATIONS

This application claims priority to U.S. provisional application Ser. No. 63/401,221 filed Aug. 26, 2022 and is hereby incorporated by reference.

### BACKGROUND

### Field

The application relates to supply chain systems that leverage artificial intelligence and machine learning recommendations for predicting customer and product combinations in an e-commerce environment.

### Background

Historically, vendors have offered specific product combinations to their customers based on various criteria. This decision making was often tied to the customer's purchase history, the vendor's product inventory, and the market trends at the time. However, such methods were not without their drawbacks, as there's always a risk of not predicting correctly what the customer might want to purchase next, thus potentially missing out on sales opportunities.

More recently, AI has been leveraged to predict the products that might interest a customer. This provides an attractive proposition to customers, improving their shopping experience and potentially increasing sales conversion rates.

However, in some cases, the predictions made by these AI models may not be as accurate as desired, leading to less than ideal product recommendations. Therefore, there is a need to further enhance the AI prediction models to improve the accuracy of product recommendations for customers.

The inventors have identified a number of problems in the ordering, sale, shipping of industrial products. Industrial products for the purpose of this solution comprise bulk shipped items further comprising construction materials, bulk plastics (e.g. plastic film), injection molding supplies, and other products ordered in bulk

The first problem identified by the inventors is the difficulty in ordering bulk industrial supply items from a single ordering point. Most industrial products are ordered under contractual arrangements that are unique to each purchaser. As suppliers and manufacturers are added to a sales offering the complexities grow exponentially managing, specific product properties being ordered, sales minimums, discounts, return credits, variances off the contract rules. Thus there is a causality and cascading set of elements that must be considered in accurately pricing and vending a complex mix of products.

A second problem identified the inventors is that there is an active disconnection between how industrial items are ordered v. the quantities specified are shipped and delivered. For example, a vendor may order a product specified in a length and width when its shipping nomenclature may be in pallets or rolls or truckloads. The problem compounds if there are additional distributors ordering a mix of products in quantities that are familiar to the user and that there is a separate fulfillment organization which forces the logistics and supply chain teams to translate, convert, and validation those orders in shipping elements.

A third problem identified by the inventors it that the repeating orders by customers are subject to market changes and pressures in the supply chain. These changes in many cases are either not caught by the supplier and would result in lost revenue if not accounted for. This problem compounds and creates a constant drain on seller resources to check, catch and amend orders to reflect this price/market modifiers.

The next problem identified by the inventors is the management of complex sets of rules for industrial product orders is error prone. No previous solution adequately handles complex sets of order attributes that must be satisfied by the order rules set by each vendor with regards to a unique customer with a unique set of product need. Errors can also compound when a customer procurement department is involved in volume or contractual price negotiations. The procurement department in many cases will wrongly push for discounts that they haven't bargained for. They in many cases will start and stop in the procurement process and will forget variances agreed to/denied by seller(s) previously

Another problem identified by the inventor is that customers receive discounts and variances based on contract negotiations based on the status or identity of the customer (E.G. GSA pricing or most favored nation clauses) Most favored nation clauses in particular are troublesome to manage as they require the seller to capture and identify variances in other contracts and to then import the price given in another contracts

Another problem identified by the inventors are supply chain promises. With the specter of global transshipment and backlogs in ports or arrival, estimates on shipping in many cases are not readily identified or updated in existing systems. Furthermore, the ability to mix/match and combine transshipment across a number of manufacturers are not identified with any frequency. Thus scaled and bundled shipments that could be combined for shipping are rarely identified. The problem of when to bundle and where to bundle in shipping is also an identified problem for the inventors.

### BRIEF SUMMARY

Systems and methods are provided for predicting customer and product combinations using AI in an e-commerce setting. These predictions are made, at least in part, based on the specific products being browsed or purchased. In some cases, it is also based on customer-specific information, such as their past purchase history.

According to one aspect of the present solution, there is provided an automated method in an e-commerce platform comprising: receiving customer input selecting at least one product for purchase; making a prediction of potential product combinations of interest to the customer, wherein the prediction is made, at least in part, on specific procurement rules for that customer, the particular vendor, or on the at least one product selected for purchase; presenting these predicted product combinations to the customer through the user interface.

In some solution variants, the method further comprises: using machine learning to determine a product specific variable for products available for purchase, wherein making the prediction is based on the product specific variable for each of the selected at least one product.

In some solution variants, making the prediction is also based on a vendor specific variable.

In some solution variants, the method further comprises: maintaining a history of online sales for the vendor; determining the vendor specific variable based on this sales history; from time to time, updating the vendor specific variable to reflect changes in the sales history.

In some solution variants, making the prediction is also based on a customer specific variable.

In some solution variants, the method further comprises: using a machine learning engine to determine the customer specific variable, the machine learning engine trained using historical data that correlates customer behavior while interacting with e-commerce platforms with product purchase likelihood.

In some solution variants, the method further comprises: providing a customer facing interface for receiving said customer input as a web page.

Another aspect of the present solution, there is provided a product recommendation apparatus comprising: an interface for receiving customer input from a customer facing interface selecting at least one product for purchase; a product combination prediction generator configured to make a prediction of potential product combinations of interest to the customer, wherein the prediction is made, at least in part, on a product specific variable specific to the at least one product selected for purchase; a product specific variable determiner configured to determine the product specific variable for the at least one product; a customer facing interface configurator that configures a user interface within the customer facing interface based on the prediction.

In some solution variants, the product recommendation apparatus further comprises: a product specific machine learning engine configured to determine a product specific variable for products available for purchase, wherein making the prediction is based on the product specific variable for each of the selected at least one product.

In some solution variants, the communications server apparatus further comprises: a vendor specific variable determiner configured to determine a vendor specific variable; wherein the product combination prediction generator makes the prediction also based on the vendor specific variable.

In some solution variants, the communications server apparatus further comprises: a computer readable storage maintaining sales history for the vendor's online sales channel; wherein the vendor specific variable determiner determines the vendor specific variable based on the sales history, and from time to time, updates the vendor specific variable to reflect changes in the sales history.

In some solution variants, the communications server apparatus further comprises: a customer specific variable determiner; wherein the customer specific variable determiner determines a customer specific variable; wherein the product combination prediction generator makes the prediction also based on the customer specific variable.

In some solution variants, the communications server apparatus further comprises: a machine learning engine configured to determine the customer specific variable, the machine learning engine trained using historical data that correlates customer behavior while interacting with e-commerce platforms with product purchase likelihood.

According to another aspect of the present solution, there is provided an e-commerce platform comprising the product recommendation apparatus described herein.

In some solution variants, the solution combines predictive bundling of complex industrial product ordering using a number of heuristic rules personalized to a particular customer with an online ordering and shipping system. This solution also manages minimum order quantities, special offers or unique customer variances normally addressed in a contract management system. The solution solves the problem of converting user ordering nomenclature to logistical nomenclature for the manufacturer(s) using the system. The invention also solves the problem of selling and cross selling across multiple suppliers and their respective products, their purchasing rules, as well as their mandated shipping rules are held in multiple data services in the cloud and are accessed as needed by various users of the system. The system also combines portals for direct sales, consultative selling, and pure online ordering inputs for the users. The solution also engages with a number of user portals to manage and enable quick and complete hand offs to various users in the sales cycle. User portals comprise: salespersons, account management, procurement, shipping and accounting interfaces.

In some solution variants, the predictive bundling solution offers suggested orders, projected minimum spends, various product bundles that satisfy contract minimums with the customer and seller rules/minimums.

In some solution variants at the macro-level, the predictive bundling solution provides logistical suggestions for transshipment, suggestions for bundled orders representing the needs of multiple purchasers and midpoint shipping solutions that will receive, split and reship the correct quantities to their respective purchasers. These logistical solutions can be proposed in a shipment sharing to the ordering customers and receive their approval to combine the shipments or this may be an internal process if the platform user

According to another aspect of the present solution, there is provided an e-commerce platform comprising the predictive bundling solution and a product recommendation apparatus described herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

### BRIEF DESCRIPTION OF THE DRAWINGS

Solution variants of the disclosure will now be described with reference to the attached drawings in which:

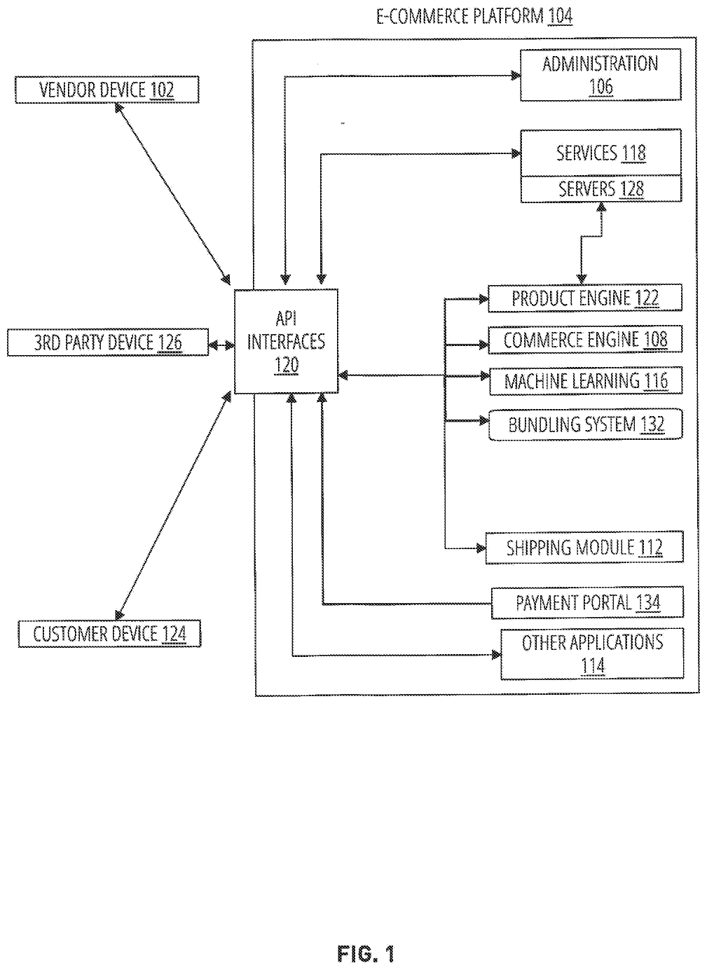

FIG. 1 is a block diagram of an e-commerce platform, according to one solution variant;

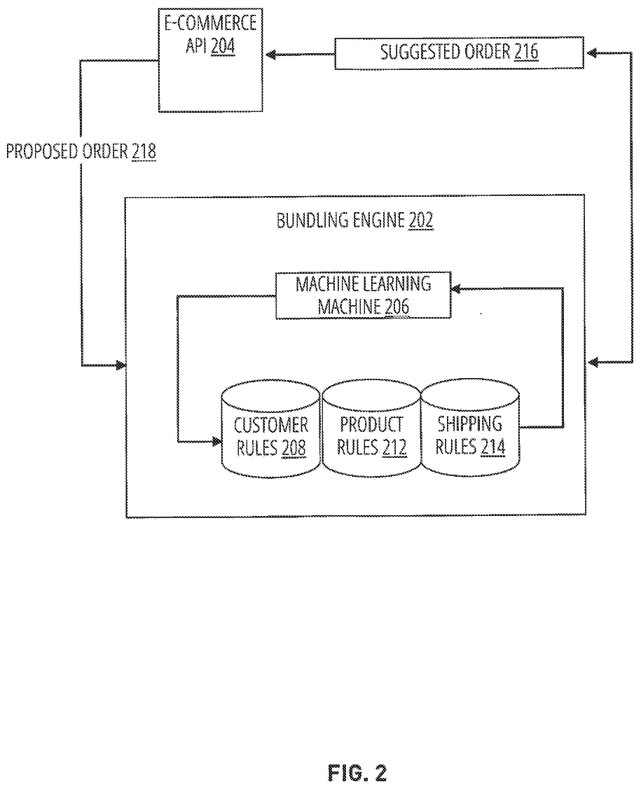

FIG. 2 is a block diagram of a predictive bundling system according to one solution variant.

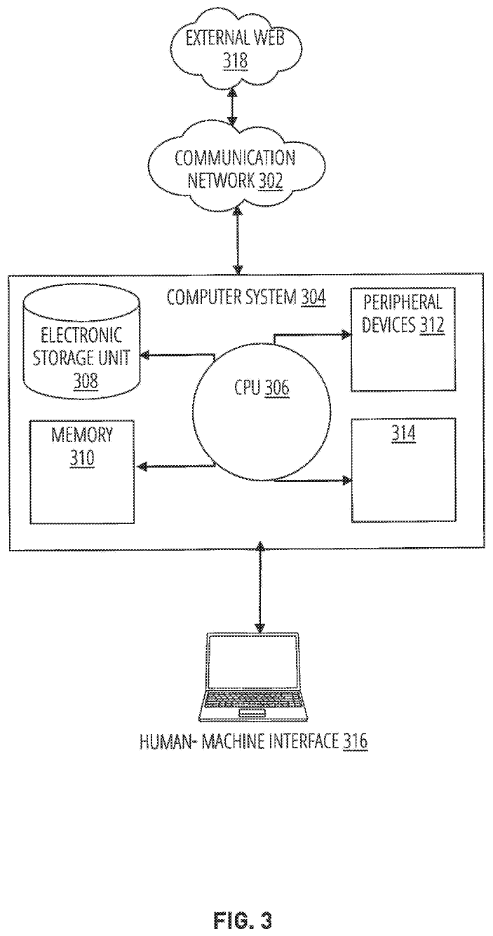

FIG. 3 illustrates a computer system that may be used to predict and provide product combinations to customers, according to one solution variant; and

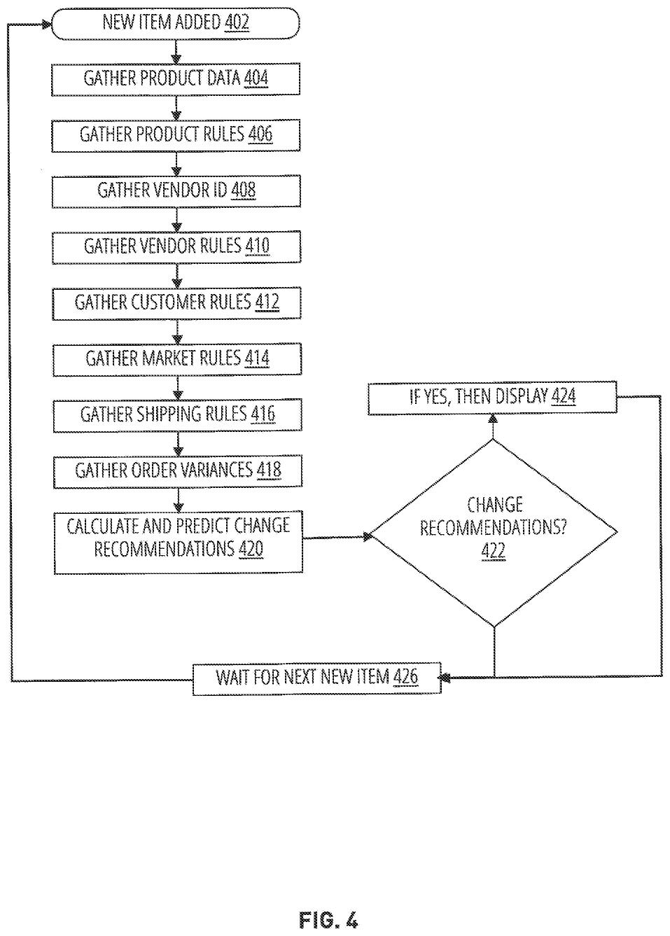

FIG. 4 is a flowchart of a method for predicting and providing product combinations to customers, according to one solution variant.

### DETAILED DESCRIPTION

The following disclosure provides a detailed description of various illustrative solution variants of an e-commerce platform having complex and predictive bundling engines. These solution variants are presented without limitations and are accompanied by drawings and exhibits for reference. It should be noted that the disclosure can take various forms and is not confined to the examples mentioned herein. The purpose of these solution variants is to comprehensively convey the concept of the disclosure to those skilled in the field. Solution variants described herein provide an interactive environment for enabling a user to order, bundle, and purchase grouped industrial products using a computing device. In particular, some solution variants described herein enable computing devices, such as web browsers or dedicated special computing machines to enables the user to request, blend, store or enable an order of industrial products across a spectrum of providers and other variable fields to achieve a complex order of industrial products

The solution generally comprises an E-Commerce platform apparatus for managing complex orders of industrial supplies, comprising a processor and a memory, the communications server apparatus being configured, under control of the processor, to execute instructions in the memory to: for a plurality of orders of respective different order quantities that have unique sets of products and rules associated with the products, each of the plurality of orders associated with a unique order rule requirements; determine, for a first order element of a first order category, a value of a first attribute parameter indicative of a first order rule requirement; determine, for a second order element of a second order category, a value of a second attribute parameter indicative of a second order rule requirement; compare the values for the first and second order attribute parameters with a minimum order rules set associated with an ordering entity; and use a comparison result to recommend an order change to at least one of the first or second order elements to the ordering entity.

Solutions described herein provide an interactive environment for enabling a user to order, bundle, and purchase grouped industrial products using a computing device. In particular, some embodiments described herein enable computing devices, such as web browsers or dedicated special computing machines to enables the user to request, blend, store or enable an order of industrial products across a spectrum of providers and other variable fields to achieve a complex order of industrial products

The solution generally comprises a communications server apparatus for managing complex orders of industrial supplies, comprising a processor and a memory, the communications server apparatus being configured, under control of the processor, to execute instructions in the memory to: for a plurality of orders of respective different order quantities that have unique sets of products and rules associated with the products, each of the plurality of orders associated with a unique order rule requirements; determine, for a first order element of a first order category, a value of a first attribute parameter indicative of a first order rule requirement; determine, for a second order element of a second order category, a value of a second attribute parameter indicative of a second order rule requirement; compare the values for the first and second order attribute parameters with a minimum order rules set associated with an ordering entity; and use a comparison result to recommend an order change to at least one of the first or second order elements to the ordering entity.

The bundling process selects a number of fields that represent useful attributes or parameters that related to a group of products, the product features or attributes, their manufacturers, their shipping options, the set of customers ordering selected combinations products, their shipping preferences, historical ordering data, among many other ordering rules and selection parameters.

The tables below are examples of product/product ordering/manufacturer/shipper/distribution platforms/customer profile data elements. Each field example comprises one or more data fields. The data fields are intended as plain language examples with examples representing one or more data elements, or compounded fields that could be subdivided in further relational tables. The tables are also not intended to be bounded or limited by a description.

Table of product and product ordering fields

| | | | | |
|---|---|---|---|---|
| | | Product | Product | |
| | | Features | Composition | Product sales |
| | Product | (multiple | physical/ | format(s) (e.g., |
| Product | Management | fields for | chemical | rolls/linear |
| ID | Data | multiple fields) | properties | feet. |

| | | | |
|---|---|---|---|
| Product | Product | Product | Product |
| shipping | Quantity | Availability | Substitutes |
| options | Ordered | | |

Product ID: A unique identifier assigned to each product, often used for inventory tracking, order processing, and in databases to differentiate products from one another.

Product Management Data: The organizational function responsible for guiding a product through its lifecycle, from conception and development to marketing and sales. It often involves strategies, planning, and execution related to product launches, positioning, and post-launch activities. Also comprising specific information or details related to a product, which can include its specifications, usage instructions, origin, expiration date, and any other relevant details.

Product Features (multiple fields for multiple fields): Specific characteristics or attributes of a product that provide value or functionality to the end-user. This attribute can contain multiple fields, each detailing different features of the product.

Product Composition physical/chemical properties: The inherent characteristics of a product, detailing its physical and chemical makeup. This can include information like material composition, chemical formula, density, melting point, and other relevant attributes.

Product sales format(s) The specific ways in which a product is packaged or sold. For instance, a product could be sold by the roll, by linear feet, in boxes, or in individual units, etc.

Product shipping options: Different methods available for delivering a product to customers, which could include options like express delivery, standard shipping, palletized delivery, and more.

Product Quantity Ordered: The number of units of a particular product that a customer or retailer has requested in a specific order.

Product Availability: The current status of a product in terms of its stock levels. It indicates whether a product is in stock, out of stock, available for backorder, or discontinued.

Product Substitutes: Alternative products that can be offered to customers when the original product is unavailable or when a customer is looking for a different option. These substitutes often have similar features or functionalities to the original product.

Table of Customer Fields

| Customer | Contract | Point of | Authorized | Balance/Credit |
|---|---|---|---|---|
| ID | ID(s) | Contact | Credit | Flags |
| Procurement | Shipping | Purchase | Product Limits | Payment |
| departments | Profiles | History | | Profiles |
| Account | Return | Market | | |
| Manager | History | | | |

Customer ID: A unique identifier assigned to each customer, used to track and manage customer information, orders, interactions, and other related activities within a system or database.

Contract ID(s): Unique identifier(s) linked to specific contracts or agreements between the customer and a service or product provider. It references terms, conditions, and any other specific details of the contractual relationship.

Point of Contact: The designated individual or department within a customer's organization responsible for communication and liaison. This usually includes contact details like name, phone number, and email.

Authorized Credit: The maximum amount of credit that a customer is allowed or has been approved for by a seller or service provider.

Balance/Credit Flags: Indicators or alerts within a system that highlight the current status of a customer's account balance or credit. This can show whether a customer is nearing, at, or over their credit limit.

Procurement Departments: The divisions or units within an organization responsible for purchasing goods and services. They handle vendor relationships, purchase orders, and related activities.

Shipping Profiles: Predefined configurations or templates that specify a customer's preferred shipping settings, such as shipping addresses, preferred carriers, and delivery methods.

Purchase History: A record of all past transactions and purchases made by the customer, detailing products bought, quantities, dates, and other relevant transaction data.

Product Limits: Restrictions or ceilings on the quantity or type of products a customer can purchase, either based on contracts, credit limits, or specific agreements.

Payment Profiles: Stored information regarding a customer's preferred methods of payment, which can include bank account details, credit card information, or other payment mechanisms.

Account Manager: The individual or representative assigned to oversee and manage a specific customer's account, ensuring that their needs are met and addressing any concerns or issues.

Return History: A record of all product returns initiated by the customer, detailing reasons for return, dates, and outcomes of the return process.

Market: The specific segment or demographic that a customer belongs to or operates within. It can also refer to the geographical or industry-specific domain in which the customer is active.

Table of Vendor Fields

| | Contract | Point of | Authorized | Balance/Credit |
|---|---|---|---|---|
| Vendor ID | ID(s) | Contact | Discounts | Flags |
| Procurement | Shipping | Purchase | Product | Payment |
| departments | Profiles | History | Limits | Profiles |
| Account | Return | Market | | |
| Manager | History | Adjustments | | |

Vendor ID: A unique identifier assigned to each vendor to help track and manage vendor-related information, orders, contracts, and other interactions within a system or database.

Contract ID(s): Unique identifier(s) associated with specific contracts or agreements between a business and the vendor. This ID references the particular terms, conditions, and stipulations agreed upon between the parties.

Point of Contact: The designated individual or department within the vendor's organization responsible for communication and liaison with the business. This usually encompasses details such as name, phone number, and email address.

Authorized Discounts: Predetermined reductions or rebates on pricing that the vendor is authorized to offer to the business, often based on volume, terms, or specific promotions.

Balance/Credit Flags: Indicators or alerts that highlight the current status of the vendor's account balance or credit with the business. They signify whether the vendor has outstanding dues, credits, or other pertinent financial conditions.

Procurement Departments: The departments or units within a business responsible for procuring or purchasing goods and services from vendors. They oversee vendor relationships, generate purchase orders, and manage related activities.

Shipping Profiles: Predefined configurations or templates that detail a vendor's preferred shipping settings, such as shipping methods, packaging preferences, and carrier preferences.

Purchase History: A record of all past transactions and purchases made with the vendor, providing information on products procured, quantities, dates, and other transaction-specific data.

Product Limits: Restrictions or caps on the quantity or type of products that a business can procure from the vendor, either due to contract stipulations, availability, or other specific agreements.

Payment Profiles: Stored details regarding a business's preferred or agreed-upon methods of payment to the vendor, which could include terms like Net 30, bank transfer details, or other payment mechanisms.

Account Manager: The individual or representative from the vendor's side assigned to oversee and manage the account with a specific business, ensuring smooth interactions and addressing any concerns or issues.

Return History: A record of all product returns made to the vendor, detailing reasons for return, dates, and outcomes of the return process.

Market Adjustments: Modifications or changes made to product pricing, terms, or offerings based on current market conditions, trends, or specific external factors affecting the vendor's operations.

These fields provide a comprehensive overview of a vendor's profile, transactional behavior, and relationship with a business, enabling streamlined operations and informed decision-making.

Table of Shipping Fields

| | | | | |
|---|---|---|---|---|
| | | | Approved | |
| | Contract | Point of | Shipping | Shipping |
| Shipper ID | ID(s) | Contact | Methods | Intermediaries |

| | | | |
|---|---|---|---|
| Shipping | Shipping | Ratings | Geographic |
| Partners | Profiles | | Limits |

Shipper ID: A unique identifier assigned to each shipper (individual, company, or organization) that facilitates tracking, billing, and management within a shipping or logistics system.

Contract ID(s): Unique identifier(s) associated with shipping contracts between the shipper and shipping service providers. This ID is used to reference specific terms, conditions, and rates agreed upon between the parties.

Point of Contact: The designated individual or department within an organization responsible for handling inquiries, issues, or communications related to shipping. This could include a name, phone number, email, or other contact details.

Approved Shipping Methods: The specific methods or modes of shipment that a shipper is authorized to use based on their contract or agreement. Examples might include ground, air, express, freight, etc.

Shipping Partners: Organizations, carriers, or entities that a shipper collaborates with to ensure the transportation of goods. This could include courier companies, freight carriers, third-party logistics providers, and more.

Shipping Profiles: Predefined configurations or templates that specify a shipper's preferred settings or methods for shipments. This can include packaging preferences, preferred shipping partners, default shipping methods, and other criteria.

Ratings: A system or scale used to evaluate the performance, reliability, or quality of shipping service providers. Ratings can be based on customer feedback, timely deliveries, damage rates, and other performance metrics.

Geographic Limits: Defined boundaries or territories where a shipper operates or where a shipping service provider can deliver. These limits can be based on countries, regions, zip codes, or other geographic criteria, and they dictate where shipments can be sent to or received from.

Table of Market Modifiers

| | | | | |
|---|---|---|---|---|
| Market Index | Material | Supply chain | Inflation | Geographic |
| Modifiers | modifiers | modifiers | modifiers | modifiers |

Market Index Modifiers are adjustments or factors applied to an index or baseline to reflect current conditions or specific influences in a given market. They help fine-tune an index for more precise and relevant applications. Here are definitions for the listed modifiers:

Material Modifiers: These modifiers account for fluctuations in the prices, availability, or quality of raw materials used in the production of goods. Such fluctuations can be due to reasons like resource scarcity, geopolitical tensions, environmental factors, or changes in demand. For example, if the cost of steel rises, this modifier would adjust a construction index to reflect increased costs for projects requiring steel.

Supply Chain Modifiers: These pertain to changes or disruptions in the process of getting a product from the manufacturer to the end consumer. They can reflect issues related to production, shipping, logistics, warehousing, distribution, or any other part of the supply chain. For instance, if a major shipping route is disrupted due to a natural disaster, this modifier would adjust to account for increased transportation costs or delays.

Inflation Modifiers: These account for the decrease in purchasing power of money over time, meaning that a unit of currency will buy less in the future than it does currently. Inflation modifiers adjust indices to reflect the current or projected inflation rate, ensuring that values represented are not eroded by inflation. For example, if the price of goods and services increases by 2% over a year, an inflation modifier would adjust a market index to reflect this change in purchasing power.

Geographic Modifiers: These factors account for variations in conditions based on location. Different regions or countries might experience different costs, regulations, demands, or other factors that affect market conditions. A geographic modifier will adjust an index to make it relevant to a specific area. For example, the cost of real estate might be higher in urban areas compared to rural ones, and thus a real estate index might use a geographic modifier to account for these differences.

In FIG. 1, The system comprises a system comprises a Vendor Device 102, an E-Commerce Platform 104, an Administration 106, a Commerce Engine 108, a Shipping Module 112, an Other Applications 114, a Machine Learning 116, a Services 118, an API Interfaces 120, a Product Engine 122, a Customer Device 124, a 3rd Party Device 126, a Servers 128, a Bundling System 132, and a Payment Portal 134. As we see a solution variant of an E-Commerce Platform 104 designed to connect vendors with customers and offer products and services. While the discussion primarily focuses on products and bundling of various combinations of products and shipment options, it should be understood that references to products also include services, digital content, subscriptions, and more. A vendor uses a Vendor Device 102 to input rules and products into the Product Engine 122 which uses Machine Learning 116 algorithms to set those rules and their relationships to the products and how they would be utilized with distinct customers who are interacting with the Commerce Engine 108. A customer using the system via a Customer Device 124 starts an order via the API Interfaces 120 which manage the order request and assigns various tasks to the other modules in the system. As an order is entered, the Bundling System 132 review the order requests and creates recommendations to bring the order into compliance with the rules established by the Vendor. The Product Engine 122 and the Commerce Engine 108 also assist the recommendations by the Bundling System 132 to suggest alternative products, discounts, delivery options if the system requires. The Machine Learning 116 manages the orders and incrementally improves the various systems and engines to learn and improve the goals and outcomes of the various predictions made by the various engines The 3rd Party Device 126 is used by other parties who may be proxies to the Vendor or the Customer including a 3rd party procurement entity Once the recommendations are made by the Bundling System 132, the order moves from preliminary to placed, the API Interfaces 120 then engages Other Applications 114 as described later in this description and the Product Engine 122, the Commerce Engine 108, the Shipping Module 112, the Payment Portal 110 to complete and deliver the order to the customer. Then Servers 128 and Services 118 are updated to reflect order status.

Throughout this disclosure, the terms “vendor” and “customer” may refer to individuals, groups, companies, corporations, or computing entities. Customers may also include use of procurement organizations using 3rd Party Device 126 to order or they may utilize more traditional methods (e.g. Telephone, fax or email) requesting that a Vendor use their Vendor Device 102 to input orders on their behalf. Additionally, the E-Commerce Platform 104 caters to various types of users, such as vendor-users (sellers, retailers, wholesalers), customer-users (buyers), prospective users, service provider users (shipping providers, financial providers), company or corporate users, information technology users, computing entity users (bots), etc.

The E-Commerce Platform 104 serves as a centralized system that provides vendors with online resources and tools to manage their businesses. These facilities are executed through software on processors within or outside the platform. The Administration 106 and Services 118 are utilized to manage and provide functionality that vendors can utilize the E-Commerce Platform 104 to manage commerce with customers through channels like online stores, physical storefronts with Point of Sale (POS) devices, and through communication facilities. The platform supports a wide range of users, including those managing physical stores, vendor websites separate from the platform, and others.

The Services 118 include: a) Online Store Management: Facilitating the creation, customization, and management of virtual storefronts for vendors to showcase their products and services.
b) Product Catalog Management: Tools to add, update, and organize products within the platform's catalog, including product descriptions, images, pricing, and inventory levels,
c) Order Management: Streamlining the process of handling and tracking customer orders, including order processing, fulfillment, and shipment tracking,
d) Payment Processing: Integrating secure payment gateways to handle online transactions and process payments from customers,
e) Shipping and Logistics: Providing shipping options and integration with shipping carriers to ensure efficient delivery of products to customers,
f) Customer Management: Tools for managing customer data, order history, and communication, including customer support features,
g) Inventory Management: Monitoring and tracking the availability of products to prevent stockouts and manage inventory levels,
h) Marketing and Promotion: Offering marketing features such as discounts, coupons, promotions, and loyalty programs to attract and retain customers,
i) Analytics and Reporting: Generating insights through data analysis and reporting on sales, customer behavior, and platform performance.
j) Security and Fraud Prevention: Implementing measures to protect the platform and users from potential security breaches and fraudulent activities,
k) Integration with Third-Party Services: Enabling integration with external services like accounting software, email marketing, and customer relationship management (CRM) systems,
l) Theme and Design Customization: Allowing merchants to customize the look and feel of their online stores using themes and design settings,
m) Mobile App and Responsive Design: Supporting mobile commerce with responsive design and mobile app development for a seamless user experience on various devices,
n) Multilingual and Multicurrency Support: Providing options for internationalization, allowing merchants to sell to customers in different languages and currencies,
o) API Integration and Developer Tools: Offering APIs and developer tools to enable third-party developers to build custom extensions and integrations with the platform,
p) Backup and Security Measures: Implementing regular data backups and security measures to protect merchant and customer data from loss or breaches.

The E-Commerce Platform 104, in particular, is a multi-tenant facility consisting of multiple virtual storefronts. Each vendors can manage one or more storefronts and offer products through various channels such as the online store, physical storefronts with POS devices, electronic marketplaces, and social media buy buttons. Customers can interact through various Customer Device 124 devices like computers, mobile devices, and POS devices. The E-Commerce Platform 104 facilitates reaching customers through online stores, physical POS devices, electronic communication facilities, and other pathways.

The E-Commerce Platform 104 can be implemented as a cloud-based service or various software delivery models (SaaS, IaaS, PaaS, DaaS, etc.). It operates on multiple platforms and operating systems.

The API Interfaces 120 functions serve up system content to customers as webpages through Servers 128 of the e-commerce platform. Webpages may contain static content (layout, format) and dynamic content (changes from one page to another). Vendors can customize the look and feel of their online store through themes, templates, and settings. They can upload images, videos, content, and data for storage by the platform.

The E-Commerce Platform 104 provides transactional facilities through different channels, including the online store, telephone, and physical POS devices. It also offers business support services such as domain services, payment services, shipping services, risk and insurance services, and vendor billing. Shipping services include features like real-time updates, tracking, automatic rate calculation, bulk order preparation, and label printing.

FIG. 2 schematically illustrates a Bundling System 132 Call to via an E-Commerce API 204 with a proposed order 218 that is sent to a Bundling Engine 202. The proposed order 218 is vetted inside the Bundling Engine 202 by the Machine Learning Machine 206 which processes the proposed order via at least the Customer Rules 208, Product Rules 212 and Shipping Rules 214 to develop a Suggested Order 216 with a number of recommendations to bring the order into compliance. The Suggested Order 216 is then sent back to the customer for acceptance or further changes.

The components of FIG. 1 and FIG. 2 can be implemented on one or more computing devices. The computing devices can be servers, desktop or laptop computers, electronic tablets, mobile devices, or the like. The computing devices can be located in one or more locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

Web Application: In some cases, the user application may be a web application. The web application may allow the user to place an order and receive shipping information or other communications necessary to retrieve a product from a retailer. A web application may be created upon a software framework such as Microsoft® .NET or Ruby on Rails. A web application, in some instances, utilizes one or more database systems including, by way of non-limiting example, relational, non-relational, feature oriented, associative, and XML database systems. Web applications may be written in one or more versions of one or more languages. In some cases, a web application is written in one or more markup languages, presentation definition languages, client-side scripting languages, server-side coding languages, database query languages, or combinations thereof.

Mobile Application: In some cases, the user application may be a mobile application. The mobile application may run on a mobile device (e.g., an electronic tablet, a smart phone, or a smart watch). The mobile application may allow the user to place a bundled order and receive shipping information or other communications necessary to retrieve information about a bundle and issues instructions for the bundle.

Mobile applications may be written in several languages. Suitable programming languages include, by way of non-limiting example, C, C++, C#, Featureive-C, Java™ Javascript, Pascal, Feature Pascal, Python™, Ruby, VB.NET, WML, and XHTML/HTML with or without CSS, or combinations thereof. Suitable mobile application development environments may be available from several sources. Commercially available development environments include, by way of non-limiting example, AirplaySDK, alcheMo, Appcelerator®, Celsius, Bedrock, Flash Lite, .NET Compact Framework, Rhomobile, and WorkLight Mobile Platform. Other development environments may be available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for distribution of mobile applications including, by way of non-limiting example, Apple® App Retailer, Android™ Market, BlackBerry® App World, App Catalog for webOS, Windows® Marketplace for Mobile, Ovi Retailer for Nokia® devices, Samsung® Apps, and Nintendo® DSi Shop.

Standalone Application: In some cases, the user application may comprise a standalone application, which is a program that may be run as an independent computer process, not an add-on to an existing process, e.g., not a plug-in. Standalone applications are sometimes compiled. In some instances, a compiler is a computer program(s) that transforms source code written in a programming language into binary feature code such as assembly language or machine code. Suitable compiled programming languages include, by way of non-limiting examples, C, C++, Featureive-C, COBOL, Delphi, Eiffel, Java™, Lisp, Python™, Visual Basic, and VB .NET, or combinations thereof. Compilation may be often performed, at least in part, to create an executable program. In some instances, a computer program includes one or more executable complied applications.

Web Browser Plug-In: In some cases, the user application may comprise a web browser plug-in. In computing, a plug-in, in some instances, is one or more software components that add specific functionality to a larger software application. Makers of software applications may support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. In some cases, web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. The web browser, in some instances, is a mobile web browser. Mobile web browsers (also called micro-browsers, mini-browsers, and wireless browsers) may be designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

Computer Systems: The present disclosure provides computer systems that are programmed to implement methods of the disclosure. FIG. 3 shows a Computer System 304 that is programmed or otherwise configured to perform the methods described herein. The Computer System 304 can regulate various aspects of the present disclosure, such as, for example, enrolling retailers in a distributed dropship program, receiving a product order from a user, where the user has a location, identifying one or more retailers of the plurality of retailers within a maximum distance from the location that have the product in stock by, for example, analyzing a live inventory feed from each of the plurality of retailers, transmitting, to a subset of the one or more retailers, a fulfilment request, receiving a fulfilment response from a retailer of the subset of retailers, determining whether to initiate a replenishment order for the retailer. The Computer System 304 can be an electronic device of a user or a computer system that is remotely located with respect to the electronic device. The electronic device can be a mobile electronic device.

The Computer System 304 includes a central processing unit CPU 306 (CPU, also “processor” and “computer processor” herein), which can be a single core or multi core processor, or a plurality of processors for parallel processing. The Computer System 304 also includes Memory 310 or memory location (e.g., random-access memory, read-only memory, flash memory), Electronic Storage Unit 308 (e.g., hard disk), Communication Network 302 (e.g., network adapter) for communicating with one or more other systems, and Peripheral Devices 312, such as cache, other memory, data storage and/or electronic display adapters. The Memory 310, Electronic Storage Unit 308, Communication Network 302 and Peripheral Devices 312 are in communication with the CPU 306 through a communication bus (solid lines), such as a motherboard. The Electronic Storage Unit 308 can be a data storage unit (or data repository) for storing data. The Computer System 304 can be operatively coupled to a computer network (“network”) External Web 318 with the aid of the Communication Network 302. The External Web 318 can be the Internet, an internet and/or extranet, or an intranet and/or extranet that is in communication with the Internet. The External Web 318 in some cases is a telecommunication and/or data network. The External Web 318 can include one or more computer servers, which can enable distributed computing, such as cloud computing. The External Web 318, in some cases with the aid of the Computer System 304, can implement a peer-to-peer network, which may enable devices coupled to the Computer System 304 to behave as a client or a server.

The CPU 306 can execute a sequence of machine-readable instructions, which can be embodied in a program or software. The instructions may be stored in a memory location, such as the Memory 310. The instructions can be directed to the CPU 306 which can subsequently program or otherwise configure the CPU 306 to implement methods of the present disclosure. Examples of operations performed by the CPU 306 can include fetch, decode, execute, and writeback.

The CPU 306 can be part of a circuit, such as an integrated circuit. One or more other components of the Computer System 304 can be included in the circuit. In some cases, the circuit is an application specific integrated circuit (ASIC) and in some other cases, the circuit is located on a System on Chip (SOC) device.

The Electronic Storage Unit 308 contains files, such as drivers, libraries and saved programs. The Electronic Storage Unit 308 can retailer user data, e.g., user preferences and user programs. The Computer System 304 in some cases can include one or more additional data storage units that are external to the Computer System 304, such as located on a remote server that is in communication with the Computer System 304 through an intranet or the Internet.

The Computer System 304 can communicate with one or more remote computer systems through the External Web 318. For instance, the Computer System 304 can communicate with a remote computer system of a user (e.g., a mobile phone, a laptop, a desktop computer, a smart device (e.g., a smart watch, an automated ordering device, or virtual applications like a digital twin)). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the Computer System 304 via the External Web 318

Methods as described herein can be implemented by way of machine (e.g., computer processor) executable code stored on an electronic storage location of the Computer System 304 such as, for example, on the Memory 310 or Electronic Storage Unit 308. The machine executable or machine readable code can be provided in the form of software. During use, the code can be executed by the CPU 306. In some cases, the code can be retrieved from the Electronic Storage Unit 308 and stored on the Memory 310 for ready access by the CPU 306. In some situations, the Electronic Storage Unit 308 can be precluded, and machine-executable instructions are stored on Memory 310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 304, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The Computer System 304 can include or be in communication with an electronic display contained in Human-Machine Interface 316 like a laptop. for example, to receive a product order from a user, to receive a response from a recommendation by the Computer System 304 user, to provide information associated with the one or more retailers that have the product in stock and have other attributes to help answer a query from the user, and/or to provide to the user shipping information received from the retailer. Examples of Human-Machine Interface 316 include, without limitation, a graphical user interface (GUI) and web-based user interface contained in laptops, desktops, mobile devices or other devices allowing a user to interact with the Computer System 304.

Methods and systems of the present disclosure can be implemented by way of one or more algorithms. An algorithm can be implemented by way of software upon execution by the CPU 306. The algorithm can, for example, enrolling retailers in a distributed dropship program, receiving a product order from a user, where the user has a location, identifying one or more retailers of the plurality of retailers within a maximum distance from the location that have the product in stock by, for example, analyzing a live inventory feed from each of the plurality of retailers, transmitting, to a subset of the one or more retailers, a fulfilment request, receiving a fulfilment response from a retailer of the subset of retailers, confirming a fulfilment response with the retailer from which the fulfillment response is received first, determining whether to initiate a replenishment order for the retailer.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby. The section headings used herein are for organizational purposes

FIG. 4 describes a example flow pathway showing an example of steps and calculations the predictive bundling model selects the appropriate fields from each preceding tables and begins testing the current order for sufficiency based on the full view of vendor, customer, intermediaries, shippers, market and time constraints. These steps are not required to be executed in this order, but the net effect and outcomes should be similar to the steps as outlined. In the first step, the bundling calculation occurs when a New Item Added 402 to a respective shopping cart in the platform operating the bundling steps. The next step of Gather Product Data 404, retrieves the product data and that retrieved product data will drive the following step Gather Product Rules 406. The product rules define how an item may be ordered or bundled or delivered. The next step Gather Vendor ID 408 accesses the Vendor lookup and retrieves any particular vendor rules, Gather Vendor Rules 410 that are relevant to the ordered item, this can include any contractual parameters or limitation resident in the system associated with that Gather Vendor Rules 410 action. Next the Gather Customer Rules 412 step occurs, this step resolves any unique rules surround the customer making the order. The Gather Market Rules 414 step returns any market items that will affect the price of the ordered item. The Gather Shipping Rules 416 step retrieves the shipping parameters needed to ship the product including any shipping data that relates to promised delivery or delays. The Gather Order Variances 418 step is a check to see if there are any manual or overrides approved for the customer in relation to the product ordered, current or historical. The Calculate and predict change recommendations 420 step is where all of the data is processed and compared to develop a unique signature for the item ordered in the particular shopping cart that will be compared to every other item in the order to generate a suggested change to the person entering an order. To the extent that this data incudes historical data, the Calculate and Predict Interactions 120 step will also identify historical trends in ordering and allow the solution to recommend a variance to the user of the system to bring the order into compliance with the rules associated with the other items in a particular shopping cart. The Display Decision 122 step converts the rule resolution and variances to a human readable format to a decision point Change Recommendations? 422. If there are changes, then If Yes, then Display 424 step will be displayed for the user to interact with and the system will pause to receive any changed input from the user. Otherwise the If No, then the system step of Wait for next New Item 426 step occurs and the order proceeds without a prompt. The variants of this solution contemplate triggering this bundling calculation in real time as items are added, in batch mode after an order is entered, or in some hybrid fashion. The interaction with the bundling process can be managed from any number of user portals as described earlier. In some cases an account manager will work up an order and work through the rules before presenting the order to a customer or customer procurement group

Other variants of the solution: In some variants of this solution, comprises a cloud-based e-commerce and management platform, built with a service based architecture. Key components and features of this platform comprise:
a) Interfaces: The platform is equipped with interfaces to both access and adjust platform features. Among these interfaces, there are components like a demand management interface, a order support interface, a customer interface, and a supply chain management interface;
b) Network Connectivity Facilities: These facilities offer connectivity solutions to allow procurement, ordering or network entities to connect to the platform's features. Depending on the variant, the network might involve a 5G system, Internet of Things (IoT) system, cognitive networking, or even a peer-to-peer network system. All these systems are integrated within the ordering infrastructure managed by the enterprise;
c) Adaptive Intelligence Facilities: This component empowers the platform with automation capabilities. Variants of this solution might encompass technologies like edge computing, artificial intelligence deployed in the supply chain, robotic warehouse automation, digital twins either in the supply chain or in the predictive demand chain of a particular client a IOT data collection system, or a smart contract/blockchain system facilitating transactions between vendor and customers;
d) Data Storage Facilities: Variants of the data storage solutions comprises a range of technologies from distributed data architectures, blockchain technologies, distributed ledgers to graph databases that display the hierarchical relationships of the various entities in a transaction comprising customer and vendor agents, transportation entities, shipping entities, and other intermediaries who complete the supply chain related to a client's order; and
e) Intelligent Shipment monitoring: Keeping a close watch on the products ordered, shipped and delivered to the ordering entities is crucial. This can be achieved through IoT-based monitoring or sensor systems set up in infrastructure facilities overseen by the enterprise.

The commerce platform is designed to house multiple applications as described in Other Applications 114. These tools enable enterprises to seamlessly manage their orders right from the product's listing point to its delivery by the customer. Applications could span areas such as supply chain management, demand management, intelligent product tools, enterprise resource management, and asset management functionalities. More explicitly the variants of the applications comprise:
a) Applications related to Supply Chain & Logistics comprising: Supply chain, inventory management, logistics, reverse logistics, warehousing, distribution, fulfillment, shipping fleet management, maritime fleet management, navigation, routing, and shipping management;
b) Applications related to Commerce Management & Planning: Asset management, risk management, demand management, demand prediction, demand aggregation, infrastructure management, facility management, process management, workforce management, vehicle fleet management, and enterprise resource planning;
c) Applications related to Marketing & Sales comprising: Pricing, positioning, placement, promotion, commerce, ecommerce, opportunity matching, search, advertisement, entity discovery, entity search, distribution, and delivery;
d) Applications related to Technology & Automation comprising: Blockchain, Internet of things device interfaces, smart contract, analytics, compatibility testing, compatibility management, infrastructure testing, incident management, predictive maintenance, monitoring, remote control, automation, self-configuration, self-healing, and self-organization;
e) Applications related to Financial & Regulatory: Finance, trading, tax, regulatory, payments, pricing, and finance;
f) Applications related to Safety & Security comprising: Identity management, security, safety, and vendor management;
g) Applications related to Profiling & Design comprising: Demand customer profiling, entity profiling, enterprise profiling, worker profiling, workforce profiling, product design, product configuration, product updating, product maintenance, and product support;
h) Applications related to Testing & Maintenance comprising: Product testing, kit configuration, kit deployment, kit support, kit updating, kit maintenance, kit modification, kit management, and predictive maintenance; and
i) Applications related to Virtual Environments comprising: Augmented reality, virtual reality, and mixed reality.

A specific example of a system incorporating this solution is digital twin interface. A digital twin is a virtual representation of a physical object or system. It is a real-time simulation of the object or system that can be used to predict its behavior and identify potential problems.

Digital twins are created by collecting data from the physical object or system and using this data to create a computer model. The computer model is then updated in real time with new data from the physical object or system. As described in these variants of the solution. Digital twins can be used for a variety of purposes, comprising: Predictive maintenance ordering: Digital twins can be used to predict when a physical object or system is likely to fail. This information can be used to order parts for scheduled maintenance before the object or system fails, preventing unplanned downtime and costly repairs. in this case the Customer Rules 208 established in Bundling System 132 could prescriptively order items where a request from a client's digital twin requests before it is necessary to

What is claimed is:

1. Communications server apparatus for managing complex orders of industrial supplies, comprising a processor and a memory, the communications server apparatus being configured, under control of the processor, to execute instructions in the memory to:
generate, for a plurality of orders of respective different order quantities associated with an order entity, each of the plurality of orders associated with a unique order rule set;
determine, for each unique order, a first order element of a first order category, a value of a first attribute parameter indicative of a first order rule requirement;
determine, for each unique order for a second order element of a second order category, a value of a second attribute parameter indicative of a second order rule requirement;
compare the values for the first and second order attribute parameters with a minimum order rules set associated with the order entity; and
use a comparison result to suggest an order change to at least one of the first or second order elements to the order entity.

2. The communications server apparatus of claim 1 further comprising a product engine that identifies and creates a process pause at least one of the plurality orders until the order entity submits the order change to continue the order.

3. The communications server apparatus of claim 2 wherein the product engine suggests a replacement product in accordance with the set of order rules associated with the order entity.

4. The communications server apparatus of claim 1 wherein a bundling engine generates the first order categories and the second order categories which are selected from a group of customer, vendor, shipping, market, and order variances categories.

5. The communications server apparatus of claim 4 wherein the order change that is recommended is created by an machine learning module in the bundling engine.

6. The communications server apparatus of claim 4 wherein the first order categories and the second order categories further comprise the first order attribute and the second order attribute.

7. The communications server apparatus of claim 6 wherein the first order attribute and the second order attribute are selected from a group of order attributes further comprising Order ID, Customer ID, Product ID, Quantity Ordered, Order Date, Shipping Address, Billing Address, Payment Method, Total Amount, Shipping Method, Shipping Cost, Tax Amount, Discount Applied, Order Status, Estimated Delivery Date, Tracking Number, Item Price, Order Source, Promotion Applied, Variance Applied, Affiliate ID, Warranty Option, Return Status, Currency Type, Weight, Dimensions, Payment Status, Shipping Provider, Shipping Preference, Invoice Number, IP Address, Order Modification Date, Cancellation Date, Customer Minimums, Customer Maximums, or Customer Order Rules.

8. The communications server apparatus of claim 7 wherein the bundling engine computes combinations of the first order attributes and the second order attributes to suggest an order combination that is allowed for the order entity based on the set of order rules for that order entity.

9. The communications server apparatus of claim 4 wherein a commerce engine utilizes a block chain ledger to register a transaction of the order entity when an order is placed by the order entity.

10. The communications server apparatus of claim 9 wherein the transaction of the order entity status is updated by at least an Internet of Things device attached to a shipment associated with the transaction of the order placed by the order entity.

11. A method for ordering of industrial supplies, the method comprising steps of:
providing a platform that enables a person representing an ordering entity to place orders for industrial supplies;
collecting a set of raw data that identifies a behavior of regular shopping and searching activity of the person and a set of industrial supplies that the ordering entity has historically purchased;
selecting an industrial supply item from a plurality of available industrial supplies;
aggregating the selected industrial supply item with a set of other industrial supply items also selected by the person based on a set of bundling rules in a bundling engine, the bundling engine, then bundling the aggregated selected industrial supply items into an order;
alerting the person if the order meets a collection of order rules;
assembling at least the order into a set of different shipment formats for transporting the aggregated industrial supplies identified in the order;
providing the shipment information to the person and the ordering entity to enable each parties to track the order electronically; and
confirming the order and processing a payment related to the order once a set of payment conditions are met.

12. The method of claim 11 wherein a shipping module on the platform predicts at least two shipping choices for the ordering entity and recommends changes to the order

13. The method of claim 11 wherein a machine learning engine on the platform predicts at least a compliant combination of the aggregated set of industrial supply items ordered by the person based on the collection of order rules.

14. The method of claim 13 further comprising the compliant combination of the aggregated set of industrial supply items includes an additional set of suggestions generated by the platform to satisfy an industrial supply item minimum order rule.

15. The method of claim 11 wherein the person representing an ordering entity is replaced by a machine learning engine prediction request supplied by the ordering entity.

16. An industrial commerce system, comprising:
a commerce platform with a services oriented architecture;
the commerce platform having a set of interfaces that are configured to access and configure a set of features of the platform;
a set of network connectivity facilities that are configured to direct a set of predicted outcomes to connect to the set of features of the platform;
a set of adaptive intelligence facilities that are configured to automate a set of ordering capabilities of the platform related to an at least one ordering entity using the set of features of the platform;
a set of data storage facilities that are configured to store data collected and handled by the platform;
and a set of monitoring facilities that are configured to monitor the ordering entities, a selection of products and a selection of ordering rules wherein the interfaces, the network connectivity facilities, the adaptive intelligence facilities, the data storage facilities, and the monitoring facilities are coordinated for fulfillment of an order placed by the ordering entities;
a set of applications that are configured to direct a vending enterprise to manage the order on the platform from a point of ordering to a point of customer delivery; and
at least a machine learning engine configured to generate an order recommendations, governed by a set of rules governing the order, and wherein data from one of the set of rules is used by a machine learning engine to alter the order.

17. The industrial commerce system of claim 16 wherein the machine learning engine receives a set of data from an external digital twin that is predicting a need for an item in the order.

18. The industrial commerce system of claim 16 wherein there are more than one machine learning engines used to recommend other alterations to the order.

19. The industrial commerce system of claim 16 wherein the order is registered on a blockchain ledger as a transaction.

20. The industrial commerce system of claim 16 wherein the order is tracked by an Internet of Things Device after the order is shipped.
